(19) United States
(12) Patent Application Publication
(10) Pub. No.: US 2017/0305139 A1
(43) Pub. Date: Oct. 26, 2017

(54) METHOD AND DEVICE FOR PRODUCING COMPONENTS IN A LAYERING METHOD

(71) Applicant: Voxeljet AG, Friedberg (DE)

(72) Inventor: Andreas Hartmann, Stadtbergen (DE)

(73) Assignee: Voxeljet AG, Friedberg 1 (DE)

(21) Appl. No.: 15/516,846

(22) PCT Filed: Oct. 12, 2015
(86) PCT No.: PCT/DE2015/000499

§ 371 Date: Apr. 4, 2017

(30) Foreign Application Priority Data
Oct. 13, 2014 (DE) 10 2014 014 895.5

(51) Int. Cl. B33Y 40/00; B33Y 30/00; B33Y 10/00

(52) U.S. Cl. CPC B33Y 40/00; B33Y 10/00; B33Y 30/00

(57) ABSTRACT

The invention relates to a method and a device for the continuous production of components (8) made of amorphous build material, such as particulate material or spreadable pastes, wherein the build material is applied in layers, and the [build material] is applied to a feedstock (1) that is preferably moved essentially horizontally in the form of an arc, and/or wherein the feedstock uses or has a seal with the aid of a feedstock seal.

### CLAIM OF PRIORITY

This application is a national phase filing under 35 USC §371 of International Application serial number PCT/DE2015/000499 filed on Oct. 12, 2015, and claims priority therefrom. This application further claims priority to German Patent Application Number DE 10 2014 014 895.5 filed on Oct. 13, 2014. PCT Application Number PCT/DE2015/000499 (published as WO2016/058577 A1) and German Patent Application Number DE 10 2014 014 895.5 are each incorporated herein by reference in its entirety.

### FIELD

The present invention relates to a method for producing three-dimensional components from individual layers, in which thin layers of amorphous build material, such as particulate material or spreadable pastes, is applied repeatedly and then selectively solidified to form a component cross section.

The invention also relates to a device for producing three-dimensional components.

### BACKGROUND

In the 3D printing manufacturing method, for example a thin layer of particulate material is first applied to a lowerable building platform. A type of ink-jet print head then selectively prints a liquid binder thereon. The binder bonds the loosely applied particles in a targeted manner to form a component cross section. In the beam melting manufacturing method, on the other hand, high-energy radiation can solidify the material. In conventional production systems, the components are manufactured in layers vertically from top to bottom.

In contrast, the patent application WO 2011 127 897 A2 describes a method in which individual layers of particulate material are applied at an angle that is smaller than the specific angle of repose of the particulate material to a feedstock that is moved horizontally layer by layer. It is thus possible to remove components from the back of the production system without having to interrupt the build process. At the same time, in this method it is theoretically possible to manufacture components of unlimited length.

The problem with this method is that a small angle must be selected for the feedstock, which results in large machine dimensions. The higher the component is to be, the longer must the machine be designed.

Another problem involves the linear guides for the build space coater that applies the layers of particulate material to the feedstock. The linear guidance system is complex, sensitive to contamination and difficult to seal.

Production systems, as described in WO 2014 079 404 A1, are constructed to be largely open at the back. For this reason, the process chambers of these production systems, in which the layers are applied and then selectively solidified, are not sealed against the surroundings. These production systems are therefore unusable for many methods which work with, e.g., protective gases or must be thermally insulated.

Since the conventional conveyor belts with return rollers and driving rollers have proven to be ill-suited to the production systems described above, complex transport devices are presented in the patent application WO 2013 174 361 A1. The approaches proposed therein require a large degree of manufacturing accuracy and an enormous amount of material in large production systems. In production systems for smaller components, the described approaches from patent application WO 2013 174 361 A1 are proportionately too complex, too cost-intensive and, in part, have only limited functionality.

For safety considerations as well as to establish or maintain a uniform and determined temperature or other atmospheric conditions that differ from the surroundings in the build space of the 3D printing device, it is furthermore desirable to preferably provide this build space in a closed manner. This presents a problem, in particular in continuous 3D printing methods and corresponding devices, since up to now the output tunnel has not been able to be satisfactorily sealed or closed during discharge, in particular during the continuous discharge of the components or the feedstock.

### SUMMARY

The object of the invention is therefore to provide a method and a device which make an essentially closed build space available even in the continuous method or at least mitigate or overcome the disadvantages of the prior art.

This object is achieved by a method and a device according to the aspects 1 and 6.

The invention as well as preferred specific embodiments are described below.

In one aspect, the invention relates to a device for producing three-dimensional components, comprising a build space coater in a process chamber, wherein amorphous build material, such as particulate material or spreadable pastes, may be applied in layers in a first reception plane onto a build material feedstock, and wherein a solidification apparatus is also provided in the process chamber to selectively solidify the build material, characterized in that a coater for applying build material in another reception plane up to a lower edge of a cover is provided, a conveyor belt and side walls are furthermore provided, and the cover, together with side walls and the conveyor belt, forms an impermeable entry tunnel for the material feedstock into a housing, so that the housing and the moving feedstock essentially seal the process chamber against the surroundings, preferably while the feedstock passes through this tunnel.

A reception plane in this case is understood to be the plane onto which the build material is applied. It does not necessarily have to be a straight surface but may also have a curvature. This plane also does not absolutely have to correspond to a platform or conveyor belt plane. Instead, the reception plane may also be, for example, a material cone side of the build material.

Particulate material is thus now applied to the particulate material feedstock in a plane parallel to the conveyance direction, so that this plane becomes smooth and impermeable. A kind of cover is then placed thereon, thus achieving a seal against the atmosphere when an entry tunnel into the build space or process chamber is formed through this cover, side walls of the particulate material feedstock and the conveyor belt.

Conveyor belts in this case are understood to be non-limiting but instead include any device which is suitable for receiving and continuously transporting the build material.

The device is preferably characterized in that the additional coater includes a storage tank for build material, which corresponds approximately to the width of the build space and has an opening along its underside, such that build material may flow onto the feedstock, and the build material flow stops automatically when a material-specific material cone has formed between the slot of the feedstock coater and the top of the feedstock.

This has proven to be a fast and easy-to-implement coating process.

The device described above may furthermore be characterized in that the conveyor belt is a moving plate link belt and, in particular, is a closed belt made of elastic material for positioning the feedstock of build material, and the belt is clamped from the inside and outside on its circumference by a large number of link pairs oriented transversely to the feed direction, wherein the upper links are adapted and disposed in such a way that they form a smooth, enclosed surface in the level orientation of the plate link belt, and the lower links are shaped in such a way that a reversal of the plate link belt is possible with a minimal extension of the flexible belt, e.g. via a diverter pulley.

In another aspect, the device, as described above, is characterized in that the build material is applied in such a way that the first application plane is a plane that is slanted with respect to the horizontal conveyance direction.

A device of this type has proven to be advantageous for a continuous method.

The device may furthermore be characterized in that the first application plane is a straight or a convexly and/or concavely curved plane. The application plane may be inclined at an angle with respect to the horizontal. A method of this type and a corresponding device with regard to a straight application plane at an angle to the horizontal is known from the prior art and is described, for example, in WO2011127897A2 and WO2014079404A1, which are included in the application by way of reference.

The invention furthermore relates to a method for producing three-dimensional components, in which amorphous build material, such as particulate material or spreadable pastes, is applied in layers to a build material feedstock in a first application plane with the aid of a build space coater in a process chamber, and the build material is selectively solidified via a solidification apparatus in the process chamber, characterized in that the feedstock to be moved is filled up to a lower edge of a cover and smoothed on another application side by additionally applying build material with the aid of a feedstock coater, and the cover, together with side walls and a conveyor belt, forms an impermeable entry tunnel into a housing, so that the housing and the moving feedstock essentially seal the process chamber against the surroundings while the feedstock passes through this tunnel.

In another aspect, the method may be characterized in that the build material is applied in such a way that the feedstock represents a straight build space or a convexly and/or concavely curved build space having at least one radius in the area of the build material application in the first application plane.

The method is preferably characterized in that the build material is applied in such a way that the first application plane is a plane that is slanted with respect to the horizontal conveyance direction.

In another aspect, the method may be characterized in that the feedstock is positioned on a plate link belt in the layer direction, and a combined clamping and positioning device includes at least one positioning element and at least one clamping element, wherein, to position the plate link belt, the clamping element grips multiple link pairs outside the side walls for limiting the feedstock and is subsequently positioned by the positioning element, and the clamping element may be moved also without engaging with the plate link belt.

Another aspect is the use of the device described above in a continuous building method.

Another object of the invention is to refine the method and the device of the type mentioned at the outset in such a way that the drive which moves the layer-generating tools is simplified, the area of the production system in which the feedstock exits therefrom is sealed, and the feed device for the feedstock of build material, including the component, is greatly simplified and its function significantly improved.

### OTHER ASPECTS OF THE INVENTION

In the prior art, individual layers of build material are applied on a horizontally moving feedstock of build material, such as particulate material or spreadable pastes, at an angle that is smaller than the specific angle of repose of the build material.

In contrast, the layers of build material, such as particulate material or spreadable pastes, are to be applied in the invention described below in an arc or in a curvature, which is formed, for example, according to bionic design laws (FIGS. 1a and b) and which comprise at least one radius. Build space (2) is thus arc-shaped or curved.

The arc or curvature may have both a concave (FIG. 2) and a convex (FIG. 1) design. If the build material is applied in a bionic arc shape or curvature, feedstock (1) may in some circumstances be stabilized, and the build height of feedstock (1) may be increased at a determined angle compared to the layer application. A production system having an arc-shaped or curved build space could thus have a shorter construction compared to a production system having a simple feedstock angle and the same build height.

Another advantage of the arc-shaped or curved material application is a simplification of the driving device of build space coater (3).

The function of build space coater (3) is to apply a thin layer of build material, such as particulate material or spreadable pastes. For this purpose, build space coater (3), as illustrated, for example, in FIG. 3a/3b, may be designed as a container having the same width as the build space, which has a narrow opening on its underside, from which the build material flows onto build space (2). In another method, as illustrated, for example, in FIG. 4a/4b, build space coater (3) in the form of a blade distributes a preset amount of build material over build space (2). To apply the layer, both types of build space coaters (3) are moved in parallel over the build space at a distance corresponding to the layer thickness.

In most production systems according to the prior art, the positioning device of build space coater (3) is a linear guide, which is generally disposed at the height of the build space. Due to their arrangement, the linear guides are exposed to significant contamination and must be sealed in a complex manner. Two parallel linear guides must be used for wide build spaces. Both linear guides require complex mechanical or electronic coupling. This results in high equipment costs.

In the preferred embodiment of the invention presented herein, build space coater (3) is pivoted by lever arms around a bearing whose pivot point (27) is located in the area of the center of the circle of the build space radius. Pivot point (27) and the drive are thus located outside the contaminated area and may be constructed much more easily and more cost-effectively. If the arc or the curvature include multiple radii, or if pivot point (27) is not close enough to the central point of the build space radius, the arm length may be adapted to the corresponding course of the arc or curvature.

In wide build spaces, two lever arms grip build space coater (3). The lever arms may simply be coupled via a shared shaft.

In 3D printing methods, a type of ink-jet print head (10) applies extremely fine droplets of a liquid binder onto the build space in a targeted manner. In production systems according to the prior art, this ink-jet print head (10) is also moved over the build space along a linear axis system.

If the build space is constructed in the shape of an arc or having a curvature, the print head as well as build space coater (3) may be pivoted over the build space by lever arms whose pivot point (27) is in the area of the central point of the build space radius.

Another advantage of the curved or arc-shaped build space is in its use in beam melting methods, in which the material is selectively solidified with the aid of high energy radiation such as laser radiation (14). In this case, the lens for the laser radiation may be adapted according to the build space curvature.

Another disadvantage of the production systems from WO 2011 127 897 A2 and WO 2014 079 404 A1 is that the area of the back, where feedstock (1) exits the production system, is largely open.

Certain methods, such as the beam melting method, require a process chamber (26) that is sealed against the surroundings and in which the layers are generated and selectively solidified.

The difficulty of constructing an impermeable production system lies in the process-specific, non-uniform top of feedstock (1) and the conveyor belt, which is hard to seal.

Due to the process of coating build space (2) and various other secondary processes, the top of feedstock (1) of build material is always uneven, so that process chamber (26) may never be completely sealed in this area. It is not possible to smooth out the top of the feedstock, since otherwise material would be pushed into and destroy build space (2).

In one preferred embodiment of the invention, a feedstock coater (13) smooths out all uneven areas on the top of feedstock (1) in that it fills the uneven areas with build material up to the lower edge of a tunnel cover (24). Feedstock coater (13) is preferably constructed in the form of a container which is essentially the same width as the build space and which is slotted along its underside in such a way that build material may flow onto the feedstock. Feedstock coater (13) is mounted above feedstock (1) at a determined distance from feedstock (1), e.g. 5 mm above the highest possible hill. Feedstock coater (13) is continuously supplied with build material and fills every uneven area on feedstock (1). Once an uneven area has been filled, the flow of particulate material automatically stops when the specific material cone of build material has formed and thus covers the discharge slot on the underside of build space coater (13 [sic; 3]).

Tunnel cover (24) rests flush against the lower edge of feedstock coater (13) in the layer direction. Tunnel cover (24), together with conveyor belt (4) and side walls (9), forms an impermeable tunnel for feedstock (1) until feedstock (1) exits the tunnel for the purpose of laterally limiting feedstock (1). In the production system, preferably hermetically impermeable housing (20) rests impermeably against the tunnel (see, e.g., FIG. 6b).

When feedstock (1) exits the tunnel on the back of the production system, or when finished components (8) are removed at the back of the production system, feedstock (1) may partially collapse and open a connection from the surroundings to process chamber (26). To prevent this, the tunnel must be at least the same length of longest component (8) and the horizontal side length of the material-specific angle of repose. It may be sensible to detect the location of components (8) in feedstock (1) or in the tunnel, with the aid of sensors or software, so that a removal of components (8) at the wrong point in time is prevented.

Another measure for sealing process chamber (26) is the construction of the layer feeding device and the possibility to seal it against casing [sic; housing] (20) of the production system. In one preferred embodiment of the invention, feedstock (1) is transported on a plate link belt (4), in which inherently stable links (16/19), preferably made of metal, clamp a closed belt (18) made of an elastic and impermeable material, such as rubber, in segments from above and from below, e.g., using screws (17). The elastic belt material allows plate link belt (4) to bend when reversing, e.g., around a return roller (23). At the same time, plate link belt (4) is impermeable in the horizontal transport position, since the rubber belt pulls the top links flush against each other. If particulate material falls between the links, the elastic material can compensate for this.

In the preferred embodiment of the invention, plate link belt (4) exits process chamber (26) with its links oriented upwardly in flush alignment in such a way that it is sealed from above with the aid of contact seals in the direction of the housing. A collecting hopper (21), which discharges particulate material in a targeted manner, may be mounted on the end of the conveyor belt.

With the aid of the measures discussed above, process chamber (26), in which the layers of build material are generated and selectively solidified, is largely impermeable to the surroundings. As a result, a production system which is constructed according to this preferred embodiment of the invention makes it possible to use protective gases in the manufacturing process.

To move elastic plate link belt (4) in the production system, a combined clamping and positioning device (22) clamps multiple links (16/19) of plate link belt (4) from above and from below laterally and outside the walls for the purpose of lateral feedstock delimitation (9) and positions them in the feed direction. Belt (4) is not moved vertically in the feed direction. Combined clamping and positioning device (22) is positioned with the aid of a linear guide, e.g., a toothed rod, a screw drive or a toothed belt. When combined clamping and position device (22) reaches its end position, it releases links (16/19) of plate link belt (4) and moves against the feed direction into the starting position. In the starting position, combined clamping and positioning device (22) grips links (16/9 [sic; 19]) again, so that the positioning operation may be repeated. To achieve an optimum feed, combined clamping and positioning device (22) preferably grips at least all links (16/17 [sic; 19]) in the area of feedstock (1).

The area of plate link belt (4) on which feedstock (1) rests slides during transport on rails made of a slidable material, which are preferably oriented in the feed direction.

The advantage of this transport method is that it is very rigid compared to conventional conveyor belt positioning methods and is free of stick-slip effects. At the same time, plate link belt (4) may be positioned with the utmost accuracy in the clamped area. The invention WO 2013 174 361 A1 proposes a method, in which a conveyor belt alternately rests on two gratings, which may be alternately moved against to each other (principle of the so-called “walking beam”).

The main disadvantage of the method from WO 2013 174 361 A1 is that the connection between the positioning grating and the conveyor belt is based exclusively on friction and is thus essentially dependent on the mass of the feedstock. If the mass of the feedstock is not big enough to generate sufficient friction force between the conveyor belt and the moving grating, the feedstock will not be moved, since in practice indispensable seals between the walls for lateral feedstock limitation (9) and plate link belt (4) produce forces that counteract the advance of the belt. The method from WO 2013 174 361 A1 is thus largely suitable only for heavy feedstocks.

The structure from WO 2013 174 361 A1 is also very complex and requires extremely high manufacturing accuracies and very precisely positioned, vertical lifting units.

### BRIEF DESCRIPTION OF THE DRAWINGS

Exemplary embodiments of the invention are illustrated in the drawings.

FIG. 1a shows a perspective representation of the specific embodiment of the device, including a convex, arc-shaped (curved) build space (2).

FIG. 1b shows a perspective representation of the specific embodiment of the device, including a concave, arc-shaped (curved) build space (2).

FIG. 2 shows a perspective representation of the specific embodiment of the device, including an inclined (straight) build space (2).

FIG. 3a shows a perspective representation of the specific embodiment of the device, including an arc-shaped (curved) build space (2) in a 3D printing method, in a method step in which a layer of particulate material is applied.

FIG. 3b shows a perspective representation of the device from FIG. 3a, in a method step in which ink-jet print head (10) applies a binder.

FIG. 4a shows a perspective representation of the specific embodiment of the device, including an arc-shaped (curved) build space in a beam melting method, in a method step in which a layer of particulate material is applied.

FIG. 4b shows a perspective representation of the device from FIG. 4a, in a method step in which laser (14) solidifies the build material layer to form a component cross section.

FIG. 5 shows a perspective representation of a section of plate link belt (4), as used in the preferred embodiment of the device.

FIG. 6a shows a perspective representation of the specific embodiment of the device, including the housing.

FIG. 6b shows a perspective sectional representation of the specific embodiment of the device, including the housing (20).

FIG. 7a shows a perspective representation of the specific embodiment of clamping and positioning device (22) for plate link belt (4), in a method step in which the clamping device is open and moves into the initial position.

FIG. 7b shows a perspective representation of the specific embodiment of clamping and positioning device (22) for plate link belt (4), in a method step in which the clamping device clamps the plate link belt and moves it in the feed direction.

FIG. 8 shows a sectional view of a specific embodiment of the device, including the housing.

FIG. 9 shows a perspective representation of a specific embodiment of the device according to FIG. 8, including the housing.

### DETAILED DESCRIPTION

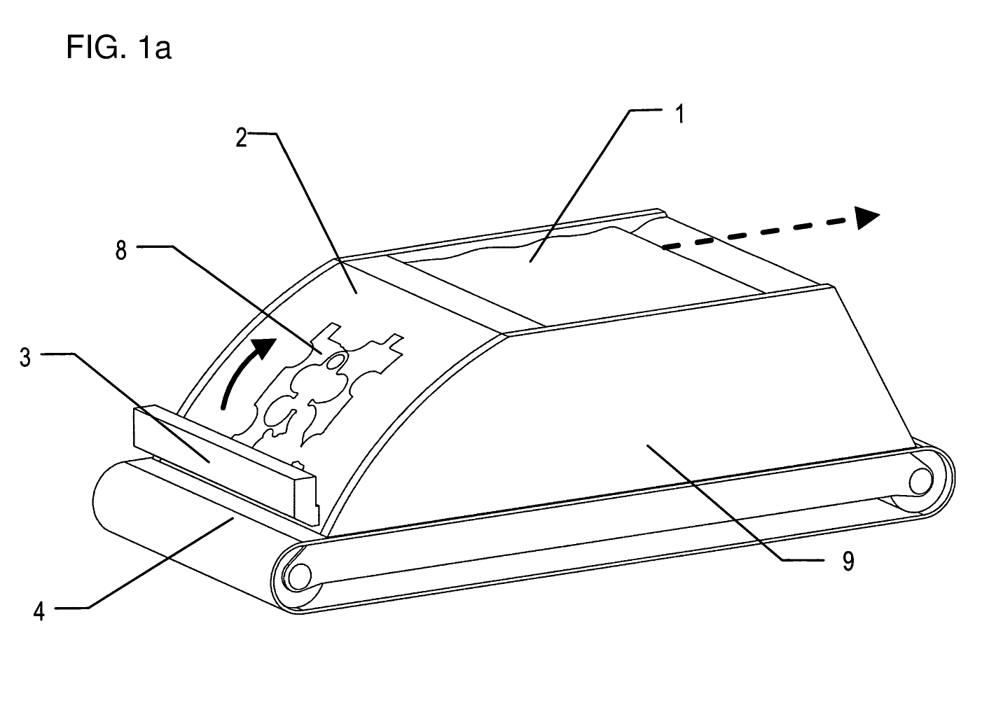

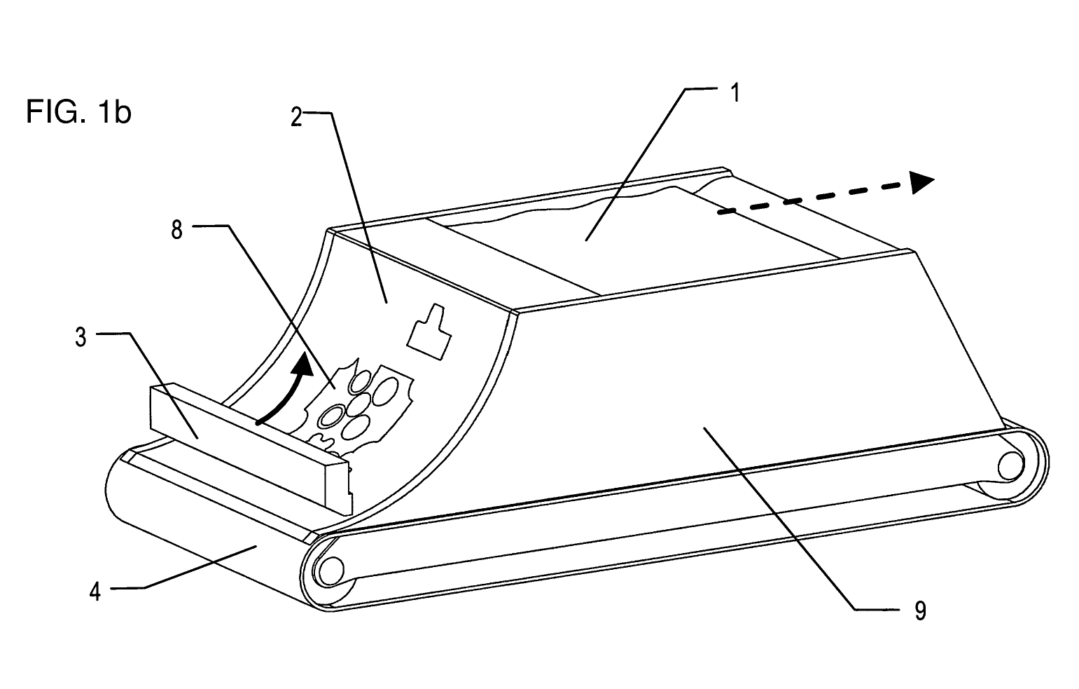

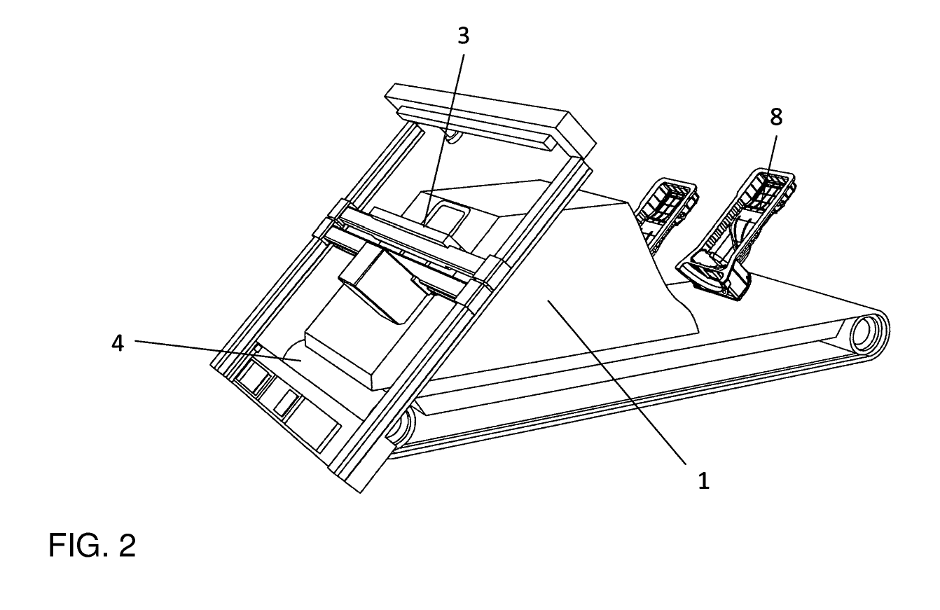

FIG. 1a and FIG. 1b show a preferred embodiment of the invention, in which the build space is constructed in the shape of an arc (curvature) and comprises at least one radius. In FIG. 1, the build space is shown with a convexly bent or curved build space (2). In contrast, build space (2) in FIG. 2 is formed in a concavely bent or curved shape.

FIG. 2 shows a so-called continuous inclined printer. The build space is constructed at an angle, “skewed” with respect to the conveyance direction. The use of the present invention and, in particular, the aspect of essentially closing off the build space from the outer atmosphere by using a second coater has proven to be particularly advantageous, in particular in a printer of this type.

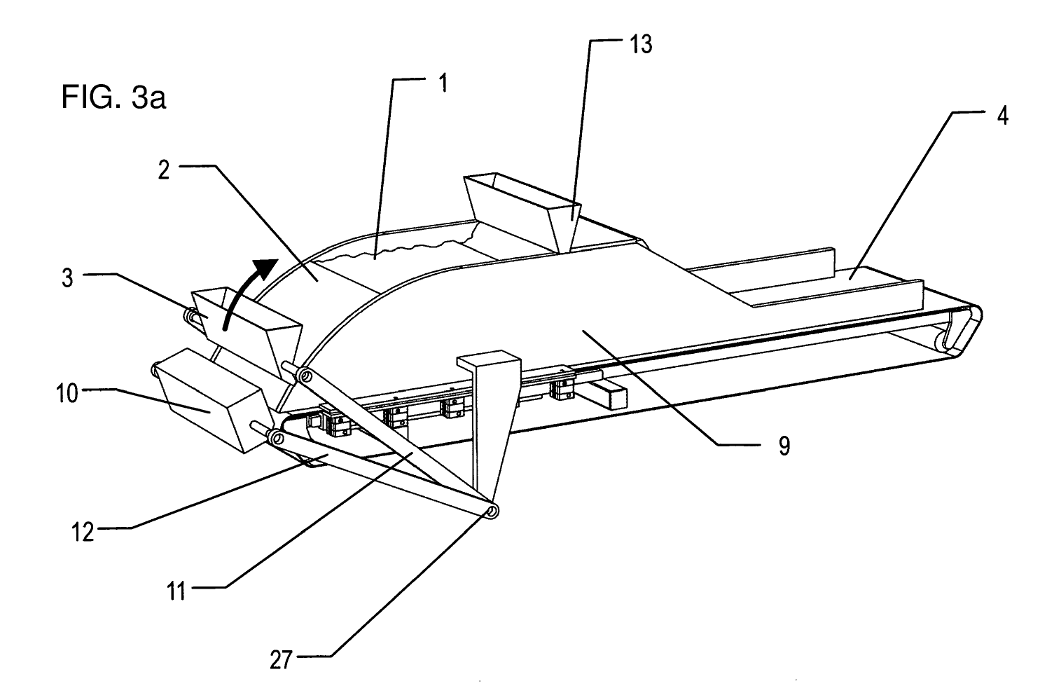

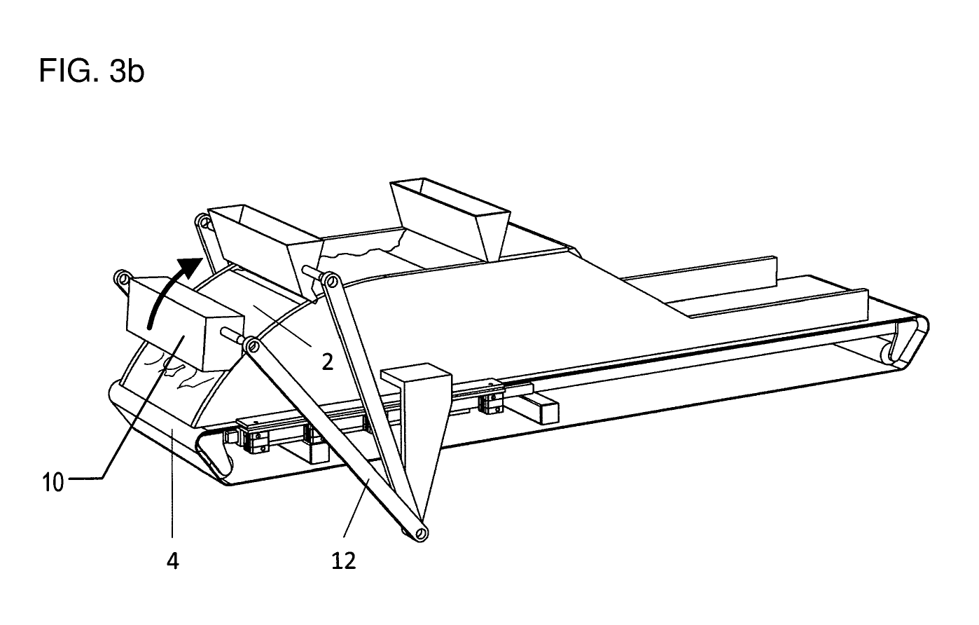

FIG. 3a and FIG. 3b show one embodiment of the device for a 3D printing method, in which a liquid binder is selectively applied with the aid of a type of ink-jet printer (10) for the purpose of solidifying a build material layer. The structure of pivot device (12) for print head (10) and pivot device (11) for build space coater (3) are clearly apparent. Both print head (10) and build space coater (3) are pivoted over the build space on lever arms. If the build space bend or the build space curvature has only one radius, pivot point (27) of particular pivot device (11/12) is essentially situated in the central point of the build space radius. If the build space bend or the build space curvature includes multiple radii, or if pivot point (27) is not close enough to the central point of the build space radius, the lever arm length must be adapted to the corresponding course of the build space. It is apparent that pivot point (27) of pivot devices (11/12) is situated outside the build area and is thus well protected against contamination by unbound build material.

FIG. 3a shows the device in a method step in which a build material layer is applied. In the illustrated embodiment, build space coater (3) is a container which is slotted on its underside. FIG. 3b shows the device in a method step in which a print head (10) is moved over the build space and selectively applies binder. Pivot device (12) may also move an axis over the build space, on which print head (10) is moved perpendicularly to the pivot direction. After a build material layer is applied, the layer feeding device (4) may push feedstock (1) by the thickness of one build material layer in the build direction.

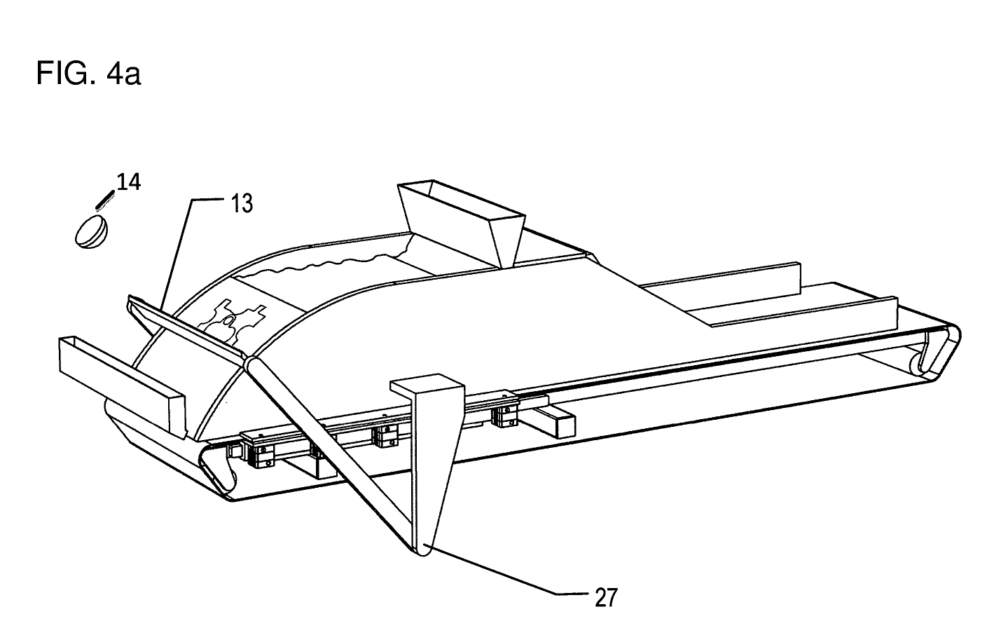

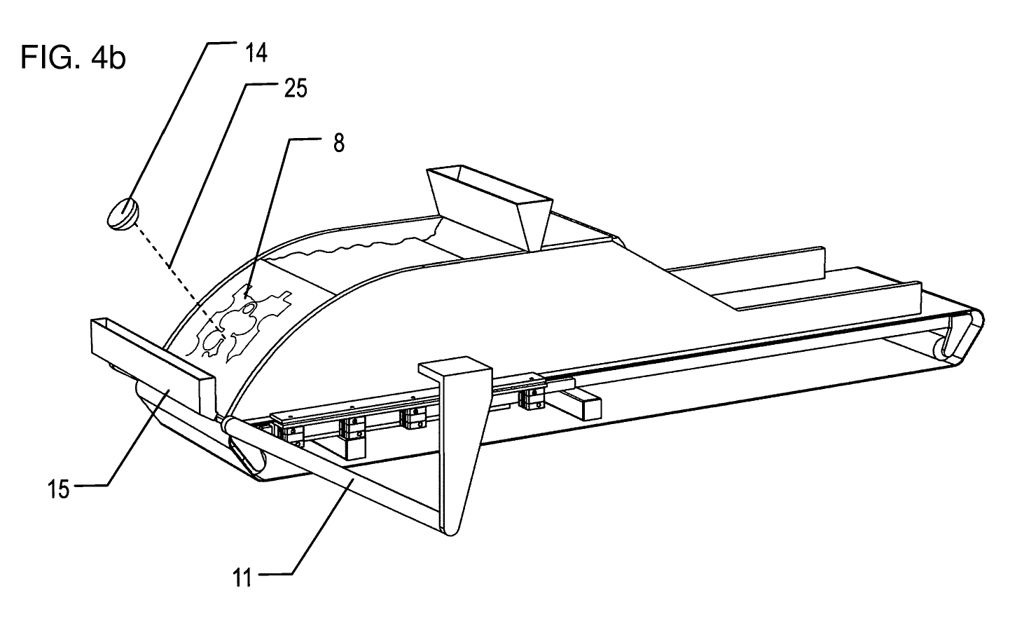

FIGS. 4a and FIG. 4b show an embodiment of the device for a beam melting method. The structure is largely identical to the embodiment of the device from FIGS. 3a and 3b.

FIG. 4a shows the device in a method step in which a layer of particulate material is applied. In contrast to the device from FIG. 4 [sic; 3], build space coater (3) is a blade which spreads particulate material over the build material. In this specific embodiment of the device, the particulate material is provided to the blade in a build space coater filling tank (15). FIG. 4b shows the device from FIG. 4a in a method step in which a laser beam (25) melts or sinters the unbound particulate material on build space (2) to form a component cross section. It is possible to adapt lens (14), through which the laser beam passes, to the shape of the build space.

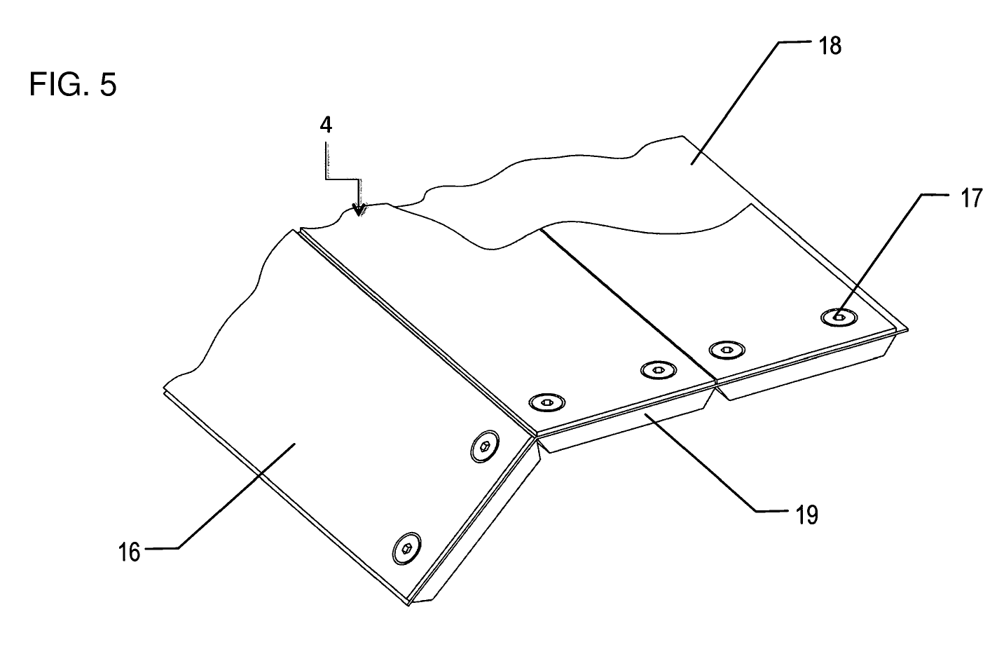

FIG. 5 shows a section of the preferred embodiment of plate link belt (4). A closed belt (18) made of an elastic and impermeable material, such as rubber, is situated in the middle. It is also possible to design this belt (18) as a fabric. Central belt (18) is repeatedly clamped by an upper link (16) and a lower link (19), e.g., using screws (17). Lower links (19) are designed with bevels and disposed in such a way that two of these links do not essentially touch each other when reversed, e.g., around a roller (23). Upper links (16) are preferably designed and disposed in such a way that, when oriented in a straight manner, the links on the top essentially touch each other and form a closed and smooth surface. The elastic belt material between the links makes it possible for the plate link belt to expand and also to compensate for pockets of particulate material in the gaps between two links.

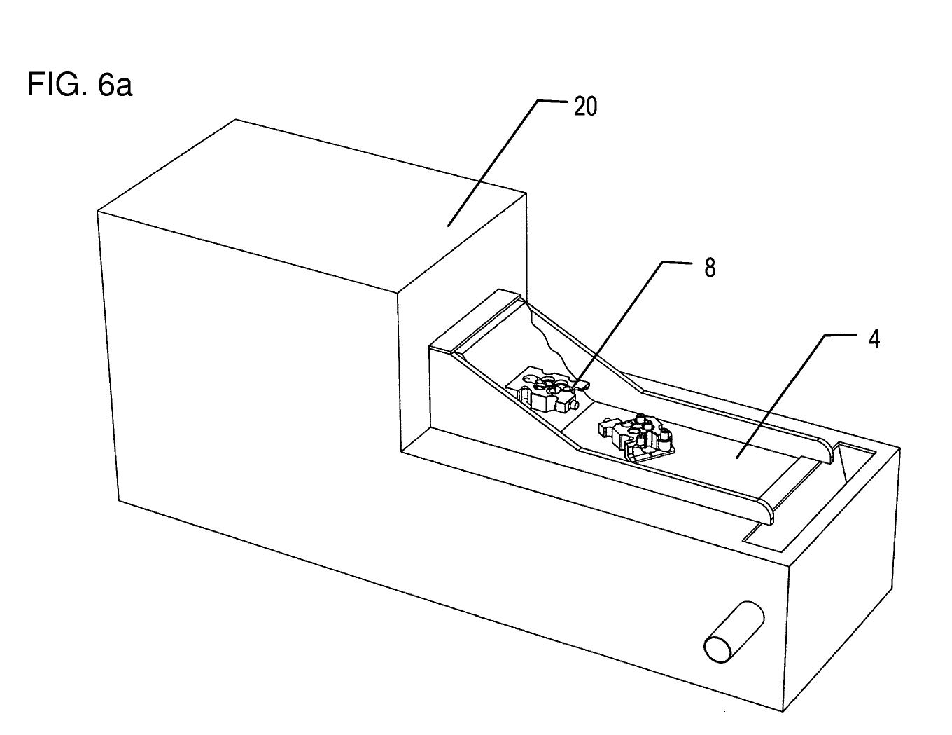

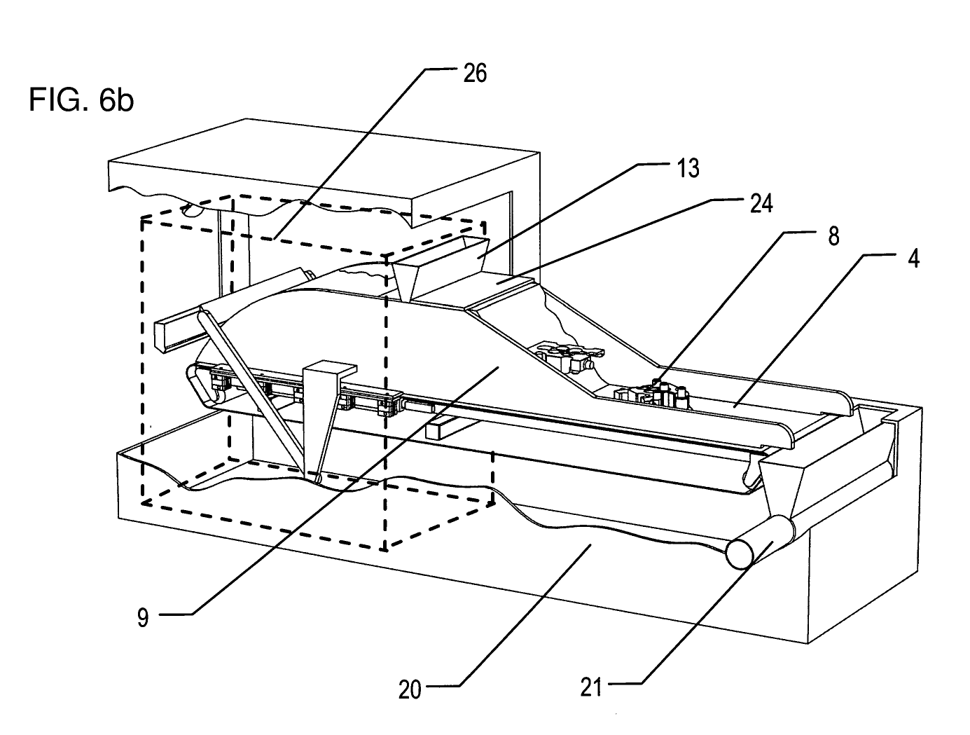

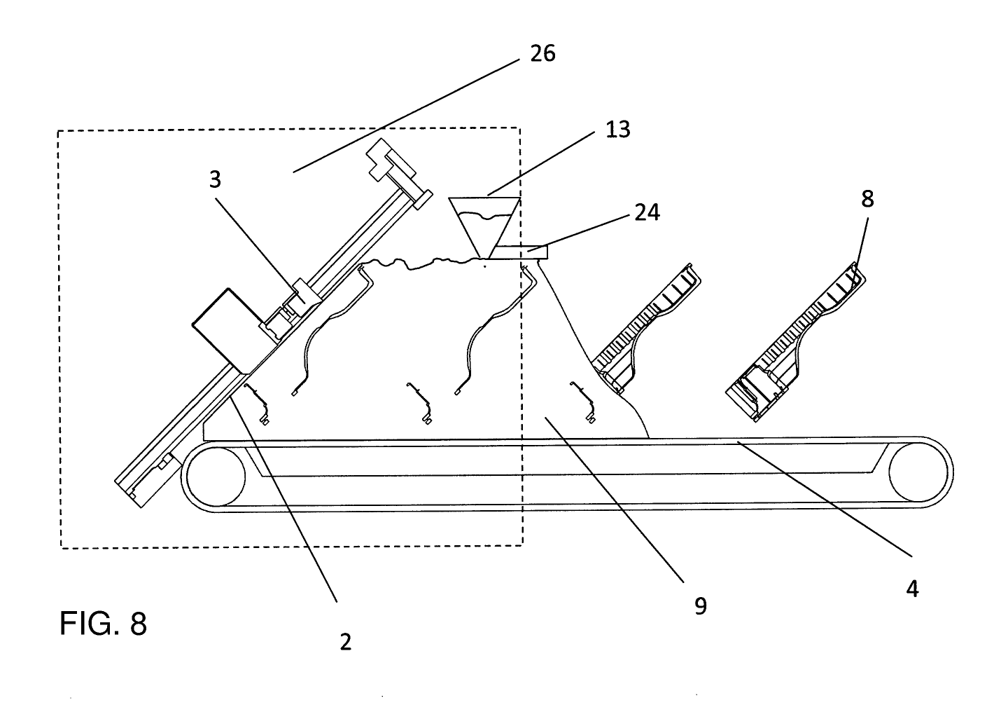

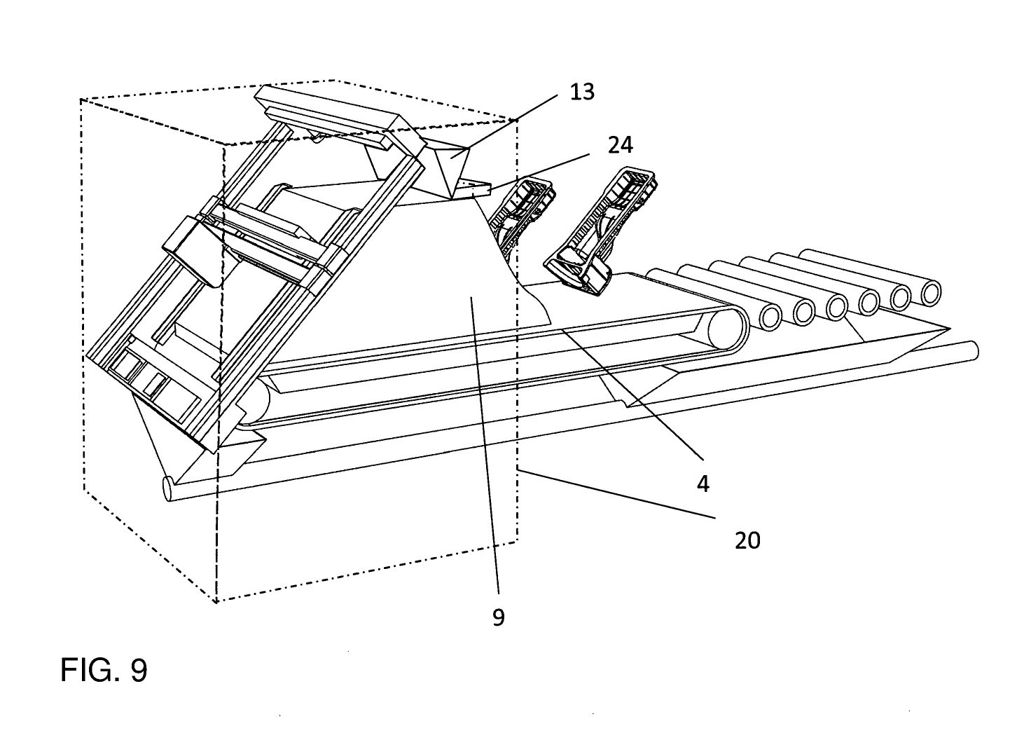

FIGS. 6a and 6b and FIG. 8 and FIG. 9 show the structure of one preferred embodiment of the invention comprising an impermeable housing (20), wherein a so-called continuous bow printer is illustrated in FIGS. 6a and 6b, and a so-called continuous inclined printer is illustrated in FIGS. 8 and 9. The area of the conveyor belt or plate link belt outside housing (20) is the area in which the finished components are removed. In this area, plate link belt (4), illustrated by way of example in FIG. 6, is fully sealed from above, e.g., via plate link belt scrapers. In the sectional representation from FIG. 6b as well as in FIG. 9, it is clearly apparent how feedstock coater (13) compensates for the uneven areas on the top of the feedstock by additionally applying material. In the conveyance direction, at the lower edge of feedstock coater (13), tunnel cover (24) abuts the coating system, and cover (24) thus forms an impermeable covering on the build material. Tunnel cover (24), together with conveyor belt (4) and side walls (9), forms an impermeable tunnel for feedstock (1) until the latter exits the tunnel. In the production system, housing (20) tightly abuts the tunnel.

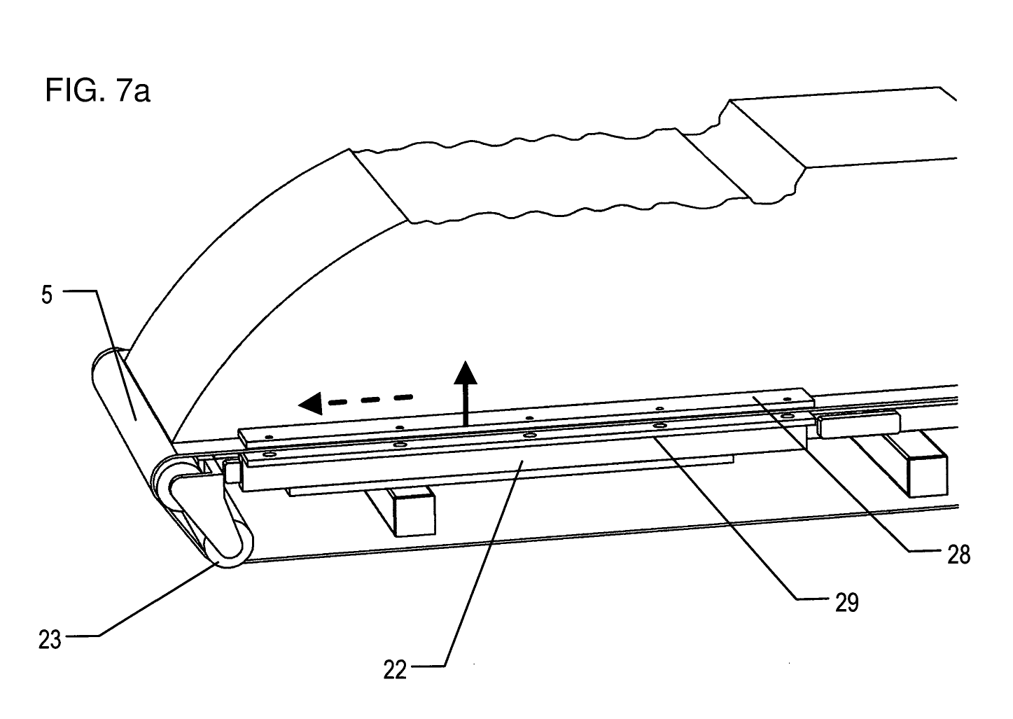

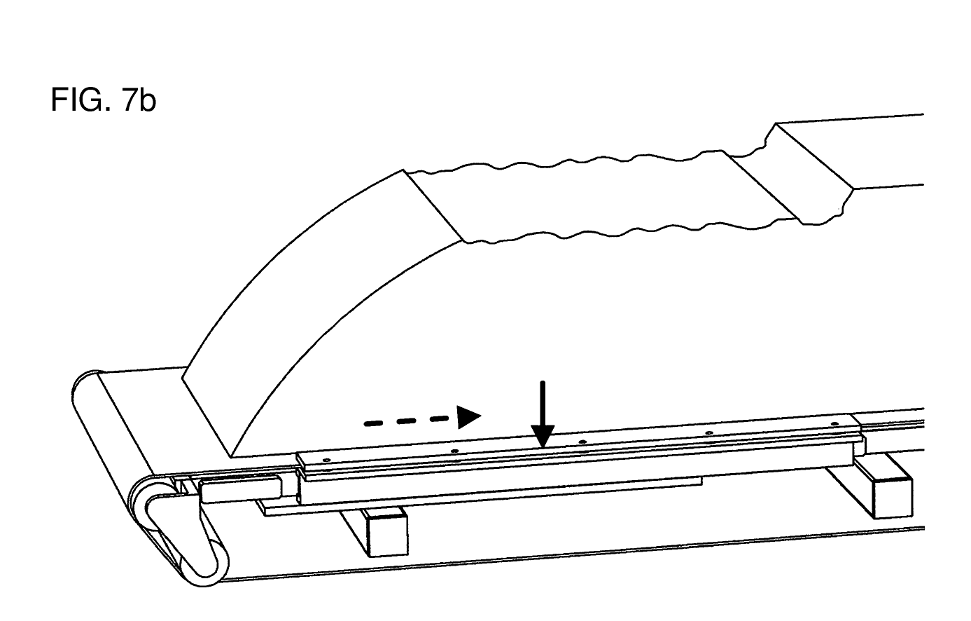

FIGS. 7a and 7b show one preferred embodiment [of the] structure of combined clamping and positioning device (22) for plate link belt (4). Combined clamping and positioning device (22) in this preferred embodiment of the invention comprises at least two clamping plates (28/29), which simultaneously grip (clamp) multiple link pairs (16/19) on the outsides of plate link belt (4) from above and from below, without lifting the belt, and also comprises a feeding device, which positions the clamping device in the build direction. The clamping action preferably takes place in that upper plates (28) are pressed downward with the aid of eccentrics or linear cylinders, and lower clamping plate (29) is fixedly connected to the positioning device.

FIG. 7a shows combined clamping and positioning device (22) on one side of the plate link belt in the open position. In this open position, combined clamping and positioning device (22) may be moved in and against the feed direction (build direction) without moving plate link belt (4) itself. FIG. 7b shows combined clamping and positioning device (22) from FIG. 7a in the closed position. In this position, multiple links (16/19) are fixedly gripped and may be positioned in the feed direction (build direction). In the area of feedstock (1), conveyor belt (4) is guided on rails, oriented in the feed direction and made of a slidable material. When combined clamping and positioning device (22) has reached its end position, the clamping device opens, as illustrated in FIG. 7a, and may be placed into the starting position. Combined clamping and positioning device (22) may be [moved] back and forth in the feed direction with the aid of linear guides, such as spindle drives, toothed rod drives or toothed belt drives.

### Other Preferred Design Aspects

A method for producing three-dimensional components, in which amorphous build material, such as particulate material or spreadable pastes, is applied in layers onto a build material feedstock (1) in a process chamber (26) with the aid of a build space coater (3), and the build material is selectively solidified in process chamber (26) by means of a solidification apparatus, characterized in that the build material is applied in such a way that the feedstock in the area of the build material application results in a convexly curved build space having at least one radius.

A method according to aspect 1, characterized in that application of build material results in a concavely curved build space having at least one radius.

A method according to one of the preceding aspects, characterized in that the build material layers are selectively solidified by the targeted introduction of energy with the aid of a laser beam, and the laser passes through a lens adapted to the shape of the build space before striking build space (2).

A method according to one of the preceding aspects, characterized in that moving feedstock (1) made of a build material is filled and smoothed up to the lower edge of a tunnel cover (24) on its top by additionally applying build material with a feedstock coater (13), and tunnel cover (24), together with side walls (9) and conveyor belt (4), forms an impermeable tunnel, which, together with housing (20) and moving feedstock (1), seals process chamber (26) against the surroundings while the feedstock passes through this tunnel.

A method according to one of the preceding aspects, characterized in that feedstock (1) is positioned on a plate link belt (4) in the layer direction, and a combined clamping and positioning device (22) includes at least one positioning element and at least one clamping element, wherein, to position plate link belt (4), the clamping element grips multiple link pairs (16/19) outside side walls (9) for the purpose of limiting the feedstock and is subsequently positioned by the positioning element, and the clamping element may be moved also without engaging with the plate link belt.

A device for carrying out the method according to at least one of the preceding aspects, characterized in that moving plate link belt (4) is a closed belt made of an elastic material for the purpose of positioning the feedstock of build material (1), and belt (18) is clamped from the inside and the outside on the circumference by a large number of link pairs (16/19) oriented transversely with respect to the feed direction, wherein upper links (16) are gripped and disposed in such a way that they result in a smooth, closed surface in the planar orientation of plate link belt (4), and lower links (19) are shaped in such a way that a reversal of the plate link belt is possible with minimal expansion of the flexible belt, e.g., via a return roller (23).

A device for carrying out the method according to at least one of the preceding aspects, characterized in that a combined clamping and positioning device (22) includes at least one positioning element and at least one clamping element, wherein, to position a plate link belt (4), the clamping element grips multiple link pairs (16/19) with at least one upper clamping plate (28) and one lower clamping plate (29), which is fixedly connected to the positioning device, outside side walls (9) for the purpose of limiting the feedstock, and is subsequently positioned by the positioning element in the layer direction, and the clamping element may be moved in the open position without engaging with the plate link belt.

A device for carrying out the method according to one of the preceding aspects, characterized in that build material is applied to the top of feedstock (1) up to the lower edge of a tunnel cover (24) with the aid of a feedstock coater (22 [sic; 13]), and the feedstock coater comprises at least one storage tank for build material, which approximately corresponds to the width of the build space and which is slotted along its underside in such a way that build material may flow onto the top of the feedstock, and the build material flow stops automatically when a material-specific material cone has formed between the slot of feedstock coater (22 [sic; 13]) and the top of feedstock (1).

A device for carrying out the method according to at least one of the preceding aspects, characterized in that build space coater (3) is pivoted by lever arms around a pivot point (27), which is situated in the area of the central point of the curved build space radius.

A device for carrying out the method according to at least one of the preceding aspects, characterized in that pivot device (11) for pivoting build space coater (3) is a worm wheel gear set.

In other preferred aspects, all aspects discussed above, as well as the aspects and features described further above, may be combined with each other.

### LIST OF REFERENCE NUMERALS

1 Feedstock of build material (particulate material or spreadable paste)

2 Build space

3 Build space coater for producing a build layer

4 Layer feed device (plate link belt)

8 Component made of solidified build material

9 Wall for lateral feedstock limitation

10 Ink-jet print head

11 Pivot device for build space coater

12 Pivot device for print head

13 Feedstock coater for producing a sealing material layer

14 Laser

15 Build space coater filling system

16 Upper link

17 Screw

18 Belt

19 Lower link

20 Housing

21 Collecting hopper

22 Combined clamping and positioning device

23 Return roller

24 Tunnel cover

25 Laser beam

26 Process chamber

27 Pivot point

28 Upper clamping plate of the combined clamping and positioning device

29 Lower clamping plate of the combined clamping and positioning device

What is claimed is:

1. A device for producing three-dimensional components, comprising a build space coater in a process chamber, wherein an amorphous build material may be applied in layers in a first reception plane onto a build material feedstock, and wherein a solidification apparatus is also provided in process chamber to selectively solidify the amorphous build material, wherein an additional coater for applying a build material in another reception plane up to a lower edge of a cover is provided, a conveyor belt and side walls are furthermore provided, and the cover, together with side walls and conveyor belt, forms an impermeable entry tunnel for the material feedstock in a housing, so that the housing and the moving feedstock essentially seal the process chamber against the surroundings, preferably while the feedstock passes through the tunnel.

2. The device of claim 1, wherein the additional coater includes a storage tank for the build material, which corresponds approximately to the width of the build space and has an opening along its bottom, such that build material may flow onto the feedstock, and the build material flow stops automatically when a material-specific material cone has formed between the slot of the feedstock coater and the top of feedstock.

3. The device of claim 1, wherein the conveyor belt is a moving plate link belt.

4. The device of claim 1, wherein the build material is applied in such a way that the first application plane is a plane that is slanted with respect to a horizontal conveyance direction.

5. The device of claim 1, wherein the first application plane is a convexly and/or concavely curved plane.

6. A method for producing three-dimensional components, comprising the steps of:
applying an amorphous build material in layers in a first application plane to a build material feedstock with the aid of a build space coater in a process chamber;
selectively solidifying the amorphous build material via a solidification apparatus in the process chamber; and filling and smoothing the build material feedstock up to a lower edge of a cover on another application side by additionally applying build material with the aid of an additional feedstock coater,
wherein the cover together with side walls and a conveyor belt forms an impermeable entry tunnel in a housing so that the housing and the build material feedstock essentially seal the process chamber against the surroundings while the feedstock passes through the tunnel.

7. The method of claim 6, wherein the build material is applied in such a way that the feedstock in the area of the build material application in the first application plane represents a convexly and/or concavely curved build space having at least one radius.

8. The method of claim 6, wherein the build material is applied in such a way that the first application plane is a plane that is slanted with respect to a conveyance direction.

9. The method of claim 6, wherein the build material feedstock is positioned on a plate link belt, and a combined clamping and positioning device includes at least one positioning element and at least one clamping element, wherein, to position the plate link belt, the clamping element grips multiple link pairs outside the side walls for the purpose of limiting the feedstock and is subsequently positioned by the positioning element, and the clamping element may be moved also without engaging with the plate link belt.

10. A method comprising the steps of:
building an article using the device of claim 1,
wherein the method is a continuous building method.

11. The device of claim 1, wherein the amorphous build material is a particulate material or spreadable paste.

12. The device of claim 3, wherein the moving plate link belt is a closed belt made of elastic material for the purpose of positioning the feedstock of build material, and the belt is clamped from the inside and the outside on the circumference by a large number of link pairs oriented transversely with respect to the feed direction.

13. The device of claim 12, wherein the link pair includes an upper link and a lower link, wherein the upper links are designed and disposed in such a way that they result in a smooth, closed surface in the planar orientation of the plate link belt, and the lower links are shaped in such a way that a reversal of the plate link belt is possible with minimal expansion of the flexible belt.

14. The device of claim 2, wherein the first application plane is a convexly and/or concavely curved plane.

15. The device of claim 4, wherein the first application plane is a convexly and/or concavely curved plane.

16. The device of claim 12, wherein the first application plane is a convexly and/or concavely curved plane.

17. The method of claim 7, wherein the amorphous build material is a particulate material or spreadable paste.

18. The method of claim 16, wherein the amorphous build material and the build material applied by the additional coater device are the same.

19. The method of claim 8, wherein the conveyance direction is a horizontal direction.

20. The method of claim 19, wherein the first application plane is a convexly and/or concavely curved plane.
